(19) United States
(12) Patent Application Publication
(10) Pub. No.: US 2013/0182691 A1
(43) Pub. Date: Jul. 18, 2013

(54) Method of and Base Station for Configuring a Data Transmission Scheme Based on Data Frames in a Communication Network

(71) Applicants: Mieszko Chmiel, Wroclaw (PL); Bernd Baumgartner, Giengen (DE)

(72) Inventors: Mieszko Chmiel, Wroclaw (PL); Bernd Baumgartner, Giengen (DE)

(73) Assignee: Nokia Siemens Networks Oy, Espoo (FI)

(21) Appl. No.: 13/822,440

(22) PCT Filed: Sep. 14, 2010
(86) PCT No.: PCT/EP2010/063444

§ 371 Date: Mar. 12, 2013

(51) Int. Cl. H04W 72/04

(52) U.S. Cl. CPC H04W 72/04
USPC 370/336; 370/329

(57) ABSTRACT

A method of configuring a data transmission scheme based on data frames in a communication network is provided, wherein communication in the communication network includes a data transmission including downlink and uplink data transmissions via first and second data transmissions paths, the first and second data transmission paths including respective first and second downlink data transmission paths and respective first and second uplink data transmission paths, the downlink data transmission via the second data transmission path being delayed to the downlink data transmission via the first downlink data transmission path, the method being executed by a base station, the method including configuring the data transmission scheme such that a reduction of a base station processing time associated with processing payload data of the data transmission is prevented

### FIELD OF INVENTION

The present invention relates to the field of telecommunication, and in particular to a method of and a base station for configuring a data transmission scheme based on data frames in a communication network, a computer element, and a computer-readable medium.

### ART BACKGROUND

Introduction of the Long Term Evolution (LTE) radio access network has offered the possibility of transmitting data at high data rates and at scalable bandwidths. A LTE network architecture comprises a base station, an eNode B, residing in a cell. The base station is configured for communicating with at least one user equipment also residing in the cell for transmitting data both in downlink and uplink data transmission directions.

Communication in the LTE network (or in the LTE-Advanced network) is defined in accordance with the 3GGP Technical Specification 36.201 v.9.1. In particular, the data transmission between the user equipment and the eNode B is accomplished across a Physical Layer also referred to as “Layer 1” of the seven layer Open System Interconnection (OSI) model. Data of a downlink data transmission are transmitted over the Physical Data Shared Channel (PDSCH), the Physical Downlink Control Channel (PDCCH), and the Physical Automatic Repeat Request (ARQ) Indicator Channel (PHICH), and data of an uplink data transmission are transmitted over the Physical Uplink Control Channel (PUCCH), and the Physical Uplink Shared Channel (PUSCH). Payload data are transmitted across PDSCH and PUSCH.

The data transmission in a downlink and uplink direction is based on resource blocks distributed in time and frequency with the data being allocated in data frames using Frequency Division Duplexing (FDD) or Time Division Duplexing (TDD). A data frame comprises subframes each on which comprising a time length of one Time Transmission Interval (TTI) equaling to one millisecond (ms). For example, in a non TTI bundling FDD case, a data frame comprises 8 subframes assigned to eight Hybrid Automatic Repeat Request (HARQ) processes in each transmission direction. In general, the data frames are scalable within an available bandwidth and span either 12 sub-carriers with a sub-carrier bandwidth of 15 kilohertz (kHz) or 24 sub-carriers with a sub-carrier bandwidth of 7.5 kHz each over a slot duration of 0.5 ms. Each uplink subframe comprises 12 or 14 Single-Carrier Frequency-Division Multiplexing Access (SC-FDMA) symbols of time lengths of 66.7 microseconds (μs) to which the data to be transmitted are mapped. The symbols are separated from one another in time via a cyclic prefix (CP) duration of 4.69 μs or 16.7 μs.

Referring to FIG. 1, a data transmission 100 based on data frames 102 in the LTE network is illustrated. Here, the data transmission 100 is based on FDD and non TTI bundling. A data frame 102 comprises eight subframes 104 in a HARQ round trip period. The allocated subframe 104 of a downlink data transmission 106, 108 is sent from the eNode B to the user equipment and is received at the user equipment after a time interval “T_propagation” corresponding to a signal propagation time of the subframe 104 between the eNode B and a user equipment. The allocated subframe 104 comprises an UL Grant for an uplink data transmission sent from the user equipment.

An allocated subframe 109 of an uplink data transmission 112 comprising payload data is received at the eNode B after the time interval T_propagation corresponding to the signal propagation time of the subframe 109 from the user equipment to the eNode B. The propagation time of the downlink data transmission 106 and the propagation time of the uplink data transmission 110 are typically identical or of a similar order of magnitude. In order to timely synchronize the downlink and uplink data transmissions 106, 112, the uplink data transmission 110 is sent timely earlier by a time period “Timing Advance (TA)” based on a time of a reception of the downlink data transmission 108 in the user equipment. The time period TA comprises a time length of two times the signal propagation time T_propagation. Accordingly, subframe edges of the downlink data transmission 106 and of the uplink data transmission 112 at the eNode B are aligned in time. However, the subframe edges of the downlink data transmission 106 and the uplink data transmission 112 may not be identically scheduled in time but may vary by a small time difference depending on the eNode B implementation. A processing time of the user equipment for the data of the downlink data transmission 108 corresponds to 3 ms-TA. A processing time of the eNode B for the data of the received uplink data transmission 112 comprises a length of 3 ms.

In the following, a so called non carrier aggregation or single carrier LTE communication architecture will be assumed for the communication between the eNode B and the user equipment. Further, the eNode B comprises multiple transceiver units. Thus, a data transmission between the eNode B and the user equipment may comprise multiple data transmission paths via the multiple transceiver units for both the downlink and uplink data transmissions.

Referring to FIG. 2, the respective LTE (or LTE-Advanced) network architecture is illustrated. The eNode B 220 is configured for communicating with the user equipment 222. The eNode B 220 comprises a baseband module 224 implementing data transmission functionalities and multiple transceiver units 226, 228. The transceiver unit 226 is configured as a radio frequency (RF) module, for example an antenna, being arranged close or near the base band module 224 and being communicatively connected to the base band module 224 via an optical fiber 229. The transceiver unit 228 is configured as a remote radio head (RRH) RF module being located at a larger distance from the base band module 224 compared to the RF module 226 and being communicatively connected to the base band module 224 via an optical fiber 230. Both the RF module 226 and the RRH 228 are connected to the user equipment 222 via air interfaces. Using the remote transceiver unit 228 allows for providing an extended spatial service coverage of the eNode B 220 and ensures a uniform transmission quality across the spatial coverage range of the eNode B 220, since the communication to the remote transceiver unit 228 is still digital and therefore lossless. In particular, the RRH 228 may be arranged on bridges, in tunnels or on large buildings.

A signal sent by the eNode B 220 in a downlink data transmission may comprise first and second data transmission paths 232a, b associated with the transceiver units 226, 228. The first transmission path 232a comprises a first transmission path section 234a between the base band module 224 and the RF module 226 and a second transmission path section 236a between the RF module 226 and the user equipment 222. The second transmission path 232b comprises a first transmission path section 234b between the base band module 224 and the RRH 228 and a second transmission path section 236b between the RRH 228 and the user equipment 222. A signal sent by the user equipment 222 in an uplink data transmission may propagate also along the first and second transmission paths 232a, b.

Accordingly, transmission of data of the downlink data transmission via the different transceiver units 226, 228 may result in different reception times at the user equipment 222. In particular, the downlink data transmission via the second downlink data transmission path 232b may comprise a notable time delay compared to the downlink data transmission via the downlink data transmission path 232a which time delay may result from a longer signal propagation time along the fiber 230 compared to a signal propagation time along the fiber 229. The delayed downlink data transmission via the second downlink data transmission path 232b may lower the data transmission quality, since data transmissions via different transceivers require to be received at the user equipment synchronized in time.

It is known that a downlink data transmission via the RF module 226 may be artificially delayed such that the downlink data transmission via the first and second data transmission paths 232a, b and accordingly the uplink data transmission may be again synchronized in time.

Referring to FIG. 3 a non TTI bundling FDD based data transmission 300 via the data transmission path 232a in FIG. 2 is illustrated. The downlink data transmission 307 via the RF module 226 is artificially delayed at the eNode B 220. When selecting the delay of the downlink data transmission 307 via the downlink data transmission path 232a identical to the actual delay of the downlink data transmission via the downlink data transmission path 232b, the timing scheme of the data transmission 300 is identical to a timing scheme of the data transmission via the data transmission path 232b.

Further, the data transmission 300 is identical to the data transmission 100 except that a time delay “T_RRH” corresponding to a propagation time of the sent downlink signal from the base band module 224 to the RRH 228 via the data transmission path section 234b is introduced prior to a sending of the downlink data transmission 306 via the RF module 226. Here, T_propagation denotes a signal propagation time of a not delayed signal sent between the base band module 224 and the user equipment 222 via the RF module 226. Further, it is assumed that a signal propagation time of s signal sent between the base band module 322 and the RF module 324 is almost zero. Thus, latency is added prior to receiving the downlink data transmission 308 via the RF module 226 at the user equipment 222. The delayed downlink data transmission 307 via the RF module and the uplink data transmission 312 are synchronized to one another at the eNode B 220 in terms of an alignment in time of subframe edges of the delayed downlink data transmission 307 via the RF module 226 and the uplink data transmissions 312. Thus, an eNode B processing time of 3 ms is shortened by the time T_RRH (3 ms-T_RRH). Further, a processing time of the user equipment 222 for the downlink data transmission via the RF module 226 and the RRH 228 corresponds to 3 ms-TA.

A LTE-Advanced network also supports a carrier aggregation network in which up to five transmission carriers (so called component carriers) may be used for a data transmission, in order to increase the data transmission rate. Each of the component carriers is associated with at least one data transmission each of which comprising downlink and uplink data transmissions with the data transmissions associated with the different component carriers being separated from one another by a transmission frequency. Data sent in data transmissions associated with different carrier components may not be identical to one another.

The data transmissions associated with the different compovent carriers may employ different transceiver units such as the RF module 226 and the RRH 228 of the eNode B 220. For example, it may be possible that a first data transmission associated with a first carrier component may employ the RF module 226, whereas a second data transmission associated with a second component carrier may employ the RRH 228 or a frequency selective repeater also being arranged remote from the eNode B 220. Consequently, the data transmission associated with the first component carrier may comprise the transmission path 232a, and the data transmission associated with the second component carrier may comprise the transmission paths 232b. As explained above, there are time delays between the different downlink data transmission paths 232a, b. Further, there are time shifts between the data transmissions associated with the different component carriers. Thus, complexity is added to the problem described above in connection with the non carrier aggregation communication network architecture.

Thus, data transmissions via multiple data transmission paths may negatively impact involved nodes of a communication network. In particular, a communication quality of a multi path communication between a base station and a communication partner of the base station may be reduced.

### SUMMARY OF THE INVENTION

It may be an object of the invention to provide an improved data transmission scheme for a multi-paths communication network.

In order to achieve the object defined above, a method of configuring a data transmission scheme based on data frames in a communication network, and a base station for configuring a data transmission scheme based on data frames in a communication network according to the independent claims are provided.

According to an exemplary aspect of the invention, a method of configuring a data transmission scheme based on data frames in a communication network is provided, wherein communication in the communication network comprises a data transmission comprising downlink and uplink data transmissions via first and second data transmissions paths, the first and second data transmission paths comprising respective first and second downlink data transmission paths and respective first and second uplink data transmission paths, the downlink data transmission via the second data transmission path being delayed to the downlink data transmission via the first downlink data transmission path, the method being executed by a base station, the method comprising configuring the data transmission scheme such that a reduction of a base station processing time associated with processing payload data of the data transmission is prevented.

According to another exemplary aspect of the invention, a base station for configuring a data transmission scheme based on data frames in a communication network is provided, wherein communication in the communication network comprises a data transmission comprising downlink and uplink data transmissions via first and second data transmissions paths, the first and second data transmission paths comprising respective first and second downlink data transmission paths and respective first and second uplink data transmission paths, the downlink data transmission via the second data transmission path being delayed to the downlink data transmission via the first downlink data transmission path, the base station comprising a configuring unit configured for configuring the data transmission scheme such that a reduction of a base station processing time associated with processing payload data of the data transmission is prevented.

According to another exemplary aspect of the invention, a program element is provided, which program element, when being executed by a processor, is configured to carry out or a control a method of configuring a data transmission scheme based on data frames in a communication network as described above.

According to another exemplary aspect of the invention, a computer-readable medium is provided, in which a computer program for configuring a data transmission scheme based on data frames in a communication network is stored, which computer program, when being executed by a processor, is configured to carry out or control a method of configuring a data transmission scheme based on data frames in a communication network as described above.

In the context of this application, the term “data transmission scheme” may particularly denote principles underlying the data transmission as to timing of the data transmission and/or allocating data transmission resources usable during the data transmission. For example, a data transmission scheme may particularly define a time of sending and/or receiving data by the base station or by a communication partner of the base station. For example, a data transmission scheme may also define an amount and/or distribution of data resources usable during the data transmission.

The term “data frame” may particularly denote a unit of data transmission resources (particularly distributed in time and/or frequency) usable during a data transmission. In particular, a data frame may comprise subframes (particularly distributed in time and/or frequency).

The term “communication network” may particularly denote any network in which the base station may reside to communicate with a communication partner. In particular, the communication network may be adapted as a radio access network which may connect the communication partner of the base station with a core network. In particular, the communication partner of the base station may form part of the communication network.

The term “data transmission” may particularly denote a transfer of data, particularly payload data (for example, voice, audio and/or media) and data other than payload data (for example, data related to signaling) between the base station and a communication partner of the base station. In particular, a data transmission may be associated with one signal or more than one signal sent for transmitting the data. In particular, the term “downlink data transmission” may particularly denote a data transmission directed from the base station to a communication partner of the base station. In particular, the term “uplink data transmission” may particularly denote a data transmission directed from a communication partner of the base station to the base station. In particular, a downlink data transmission may comprise an uplink grant for an uplink data transmission, and an uplink data transmission may comprises payload data.

The term “data transmission path” may particularly denote a routing track of data of a data transmission. In particular, the data transmission path may be a physical path of a signal associated with the data transmission. In particular, the downlink data transmission may comprise first and second downlink data transmission paths, and the uplink data transmission may comprise first and second uplink data transmissions paths. In particular, the first downlink data transmission path and the first uplink data transmission path may correspond to identical or different transmission paths. In particular, the second downlink data transmission path and the second uplink data transmission paths may correspond to identical or different transmission paths.

The term “the downlink data transmission via the second downlink data transmission path being delayed to the downlink data transmission via the first downlink data transmission path” may particularly denote that the downlink data transmission via the second downlink data transmission path may be sent by the base station later in time than the downlink data transmission via the first downlink data transmission path and/or that the downlink data transmission via the second downlink data transmission path may be received by a communication partner of the base station later in time than the downlink data transmission via the first downlink data transmission path.

The method, the base station, the computer program, and the computer-readable medium according to the exemplary aspects of the invention may allow for an improved data transmission scheme which may maintain or increase a base station processing time for the payload data of the uplink data transmission. Thus, the communication network and the communication quality between the base station and the communication partner of the base station may be improved, since delays of a downlink data transmission via the second downlink data transmission paths may not negatively impact the base station performance during the communication.

Next, further exemplary embodiments of the method of configuring a data transmission scheme based on data frames in a communication network will be explained. However, these embodiments also apply to the respective base station, the respective computer program, and the respective computer-readable medium.

The configuring of the data transmission scheme may comprise scheduling a sending of the uplink data transmission based on a time of a reception of the downlink data transmission via the second downlink data transmission path. In particular, the term “scheduling a sending of a data transmission” may particularly denote a definition of a timing and/or used frequency resources for the sending of the uplink data transmission. For example, the base station may initiate a sending of the uplink data transmission at a particular time point and/or a particular frequency (range). In particular, in a case in which the downlink data transmission and the uplink data transmission may comprise one signal, the signal of the uplink data transmission may be sent based on a later reception of the signal of the downlink data transmission via the second downlink data transmission path. In particular, in a case in which the uplink data transmission may comprise a signal sent via the first uplink data transmission path and a separate signal sent via the second uplink data transmission path, the base station may cause delaying the sending of the signal of the uplink data transmission via the first uplink data transmission path to approximately a time point of the sending of the signal of the uplink data transmission via the second uplink data transmission path. The sending of the uplink data transmission may be provided such that the later sending of the uplink data transmission may not negatively affect a base station processing time associated with a processing of the payload data of the uplink data transmission. Further, a processing time of the communication partner of the base station for the data of the downlink data transmission via the second downlink data transmission path may also be not reduced, since the uplink data transmission may be sent at a time based on a reception of the downlink data transmission via the second downlink data transmission path but not at a time based on a reception of the downlink data transmission via the first downlink data transmission path. Further, the data transmission scheme may be facilitated, since the downlink data transmission via the first and second downlink transmission paths may not be required to be received at an identical time at the communication partner of the base station. Thus, a performance of the communication system may be improved, since negative effects of a delay of the downlink data transmission via the second downlink data transmission path on the communication partner of the base station may be compensated.

The configuring of the data transmission scheme may comprise allocating a last symbol of a subframe of one of the data frames of the uplink data transmission for non-payload data. Thus, a base station processing time associated with the processing of the payload data of the uplink data transmission may be increased, since the duration of the payload data transmission may be shortened. In particular, the available processing time of the base station for the payload data may be increased by a time corresponding to the time length of the last symbol of the allocated subframe and optionally a time corresponding to a spare time between the last symbol and a second last symbol of the subframe, if present. In particular, since the length of the allocated subframe for the payload data may be shortened by the one symbol, the base station may start a processing of the received payload data at an earlier time point. In particular, the otherwise allocated last symbol may require significantly reduced processing time than payload data, thereby decreasing the total processing time for the allocated subframe compared to a processing time for a subframe comprising only payload data.

In particular, in a case in which a transmission time of the uplink data transmission via one uplink data transmission path may be longer than a transmission time of the uplink data transmission via the another data transmission path, the allocating of the subframe may also account for a time delay of the uplink data transmission via the one uplink data transmission path.

In particular, the allocating may comprise allocating more than one symbol of the subframe of the one of the data frames for the uplink data transmission for non-payload data. In particular, the non-payload data allocated to these symbols may comprise identical information or may comprise different information. Thus, a processing time of the base station for the data of the first uplink data transmission may be even more increased.

The allocating may comprise allocating the last symbol of the subframe of the one of the data frames of the first uplink data transmission for non-payload data for one or more frequencies. Allocating the last symbol of the subframe for more frequencies, particularly for all frequencies of an available and usable frequency band, may facilitate the allocation of data resources for the uplink data transmission, since more data resources in frequency may be usable for the payload data of the uplink data transmission and thus the allocated subframe may easily selected from all available frequency data resources. Thus, capacities of the base station associated with data processing and/or storing data during the data transmission may be increased by simplifying the data transmission scheme. In particular, a data rate of the uplink data transmission may be increased such that a reduction of payload data in the allocated subframe may be at least partially compensated.

The allocated subframe may be a last subframe of a timely continuous uplink data transmission. In particular, the term “timely continuous uplink data transmission” may particularly denote an uplink data transmission comprising timely consecutive subframes for the transmission of the payload data or an uplink data transmission comprising timely not consecutive but timely distributed subframes for the transmission of the payload data. Thus, the data transmission scheme may be also applicable to a “subframe bundling” of the uplink data transmission such that an increased amount of data may be transmitted in the uplink data transmission. In particular, in a case of subframe or TTI bundling in the LTE network or the LTE-Advanced network, the allocated subframe may be the last subframe of four subframes of a FDD based uplink data transmission or a timely last subframe of a TDD based uplink data transmission.

The non-payload data may indicate a channel quality of a (particularly previous or on-going) uplink data transmission. In particular, the non-payload data may comprise a Sounding Reference Signal (SRS) used in the LTE and LTE-Advanced network. Thus, the non-payload data may comprise data related to signaling and are thus usable for managing a transmission control of the uplink data transmission. In particular, since a processing time of the non-payload data may be significantly shorter than a processing time of pay-load data, the allocating of the last symbol for the non-payload data may reduce a total processing time of the base station for the allocated subframe. In particular, managing the transmission control of the uplink data transmission may be facilitated, since, compared to actual existing signaling procedures, another option for transmitting the non-payload data may be provided.

The scheduling may comprise defining first and second information indicating respective first and second timings for the sending of the uplink data transmission via the first and second uplink data transmission paths, wherein the first timing may be identical to the second timing. In particular, the first and second timings may indicate a spatial service coverage range of the base station for a data transmission. In particular, the first and second timings may be selected by the base station in such a way that the base station may receive the uplink data transmission via the first and second data transmission paths in a suitable time for processing the respective data. In particular, the uplink data transmission via the first and second data transmission paths may be sent earlier in time by the first and second timings based on a time of a reception of the downlink data transmission via the first and second data transmission path, respectively. Thus, conventional procedures regarding the timing of the sending of the uplink data transmission via the first and second data transmission paths in the communication network may be used, thereby facilitating a data flow control executed by the base station in terms of redundantizing a modification of already existing communication procedures in the communication network. In particular, in a case of the uplink data transmission being associated with one signal, the first and second timings may be automatically identical. In particular, in a case in which the data transmission may be associated with more than one signal, the identical first and second timings may result in a synchronization in time of the uplink data transmission via the first and second uplink data transmission paths.

In particular, the first and second timings may be identical to a timing for the sending of the uplink data transmission without the scheduling of the uplink data transmission. Thus, a spatial service coverage range of the base station conventionally defined by the timing may not be altered (particularly decreased) by selecting another value of the first and second timings compared to the conventional timing value.

In particular, the first and second information may be made available to a communication partner of the base station upon entering the spatial service coverage range of the base station.

In particular, in a case of the communication network being the LTE network and the LTE-Advanced network, the first and second timings may particularly correspond to a “Timing Advance (TA)” time indicating a biasing of a timing of a sending of the uplink data transmission being synchronized to a time of a reception of a downlink data transmission.

The data transmission via the first data transmission path may be associated with a first transmission carrier and the data transmission via the second data transmission path may be associated with a second transmission carrier. Thus, the method of configuring a data transmission scheme may be applicable to a carrier aggregation communication network architecture in which a data transmission may be accomplished via at least two transmission carriers. In particular, the downlink data transmission via the first and second data transmission paths may be associated with two separate signals, and the uplink data transmission via the first and second data transmission paths may also be associated with two separate signals. In particular, information of the data transmission sent via the different transmission carriers may be different from one another. In particular, using more than one data transmission carrier for the data transmission may increase the data rate of the data transmission, thereby significantly fastening the data transmission. In particular, in a multiple transmission carrier communication network, a sending of the downlink data transmission via the second downlink data transmission path may be later in time than a sending of the downlink data transmission via the first downlink data transmission path. In particular, delaying the uplink data transmission may increase a processing time of the communication partner of the base station for the down-link data transmission via the second data transmission path despite of the later reception of the downlink data transmission via the second data transmission path. Additionally, allocating the last symbol of the subframe of the uplink data transmission with non-payload data may compensate for a reduced processing time of the base station for the data of the uplink data transmission particularly resulting from a later sending of the uplink data transmission.

In particular, the method may comprise delaying the data transmission via the first downlink data transmission path at the base station, particularly at a point associated with an antenna connector of a transceiver unit of the base station. This may allow for an easy implementation of delaying the downlink data transmission via the first downlink data transmission path.

In the case of the LTE-Advanced network, each of the transmission carriers may be adapted as a component carrier of particularly five component carriers.

The scheduling may comprise defining the second transmission carrier, particularly the downlink data transmission via the second data transmission path associated with the second transmission carrier, as a timing reference for the sending of the uplink data transmission. In particular, the defining may comprise mapping the second transmission carrier as the transmission carrier to which the first transmission carrier (and particularly all available transmission carriers) may synchronize.

In particular, in case of the LTE-Advanced network the defining may comprise mapping the later received component carrier to a so-called primary component carrier which may represent a timing reference for the uplink data transmission via the multiple uplink transmission paths associated with the multiple component carriers. In particular, a communication partner of the base station may receive immediately upon entering a spatial service coverage range of the base station information pertaining to the primary component carrier particularly in a Primary System Information Broadcast message.

The scheduling may comprise sending information indicating that the second transmission carrier, particularly the down-link data transmission via the second data transmission path associated with the second transmission carrier, may be a timing reference for the sending of the uplink data transmission. Thus, the base station may explicitly inform the communication partner about the transmission carrier being the timing reference particularly by sending a message comprising respective information. Thus, the transmission carrier being the time reference may be dynamically adjusted in case of a change of the transmission carriers available and/or usable for the data transmission.

The data transmission via the first and second transmission paths may be associated with one transmission carrier. Thus, the method of configuring a data transmission scheme may be also applicable to single carrier or a non carrier aggregation communication network architecture in which different transceiver units of the base station may (particularly simultaneously) send the (particularly identical) data to or may receive such data from the communication partner. In particular, a delay of the downlink data transmission via the second downlink data transmission path may result from a longer signal propagation time along the second downlink data transmission path compared to a signal propagation time along the first downlink data transmission path. In particular, a delay of the downlink data transmission via the second data transmission path may result from a longer signal propagation time of a downlink signal along a signal propagation path from a basic component of the base station to a transceiver unit of the base station in terms of a location of one of the transceiver units more remote from the basic component of the base station compared to a location of another transceiver unit associated with the downlink data transmission via the first downlink data transmission path and/or being connected with the basic component of the base station via a “slower” interface. In particular, a delay of the downlink data transmission via the second data transmission path may result from a longer signal propagation time of a downlink signal along a signal propagation path from a transceiver unit of the base station to a communication partner of the base station. In particular, the scheduling of the uplink data transmission based on a timing of a reception of the downlink data transmission via the second data transmission path may be automatically accomplished by delaying the downlink data transmission via the first data transmission path particularly by a time period corresponding to a time period for transmitting the data from the base station to the remote transceiver unit.

In particular, the method may comprise delaying the data transmission via the first downlink data transmission path at the base station, particularly at a point upstream of a transceiver unit of the base station, further particularly between a base band module of the base station and the transceiver unit of the base station. This may allow for an easy implementation of delaying the downlink data transmission via the first downlink data transmission path.

The scheduling may comprise synchronizing in time the down-link data transmission via the second downlink data transmission path and the scheduled uplink transmission. In particular, the term “synchronizing in time a downlink data transmission with an uplink data transmission” may particularly denote to adjust a time shift between the downlink and uplink data transmissions. For example, data (sub-)frame edges of the downlink data transmission and the uplink data transmission may be aligned in time either at the base station or at the communication partner of the base station.

Next, further exemplary embodiments of the base station for configuring a data transmission scheme in a communication network will be explained. However, these embodiments also apply to the respective method, the respective computer program, and the respective computer-readable medium.

The base station may be an eNode B of a Long Term Evolution (LTE) communication network or a Long Term Evolution Advanced (LTE-Advanced) communication network. In particular, the LTE network may enable a non carrier aggregation network architecture, and the LTE-Advanced network may enable a single carrier network architecture or a multiple carrier aggregation communication network architecture. In particular, the data transmission of the communication in the LTE or LTE-Advanced network may be based on FDD or TDD.

In particular, the base station may be adapted as a Base Transceiver Station (BTS) of a GSM Edge Radio Access Network (GERAN). In particular, the base station may be adapted as a Node B of an UMTS Terrestrial Radio Access Network (UTRAN).

In particular, a communication partner of the base station may be a user equipment or a terminal.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION OF THE DRAWING

FIG. 1 illustrates a data transmission in a LTE radio access network.

FIG. 2 illustrates a single component carrier communication architecture of the LTE radio access network.

FIG. 3 illustrates another data transmission in the LTE radio access network.

FIG. 4 illustrates a single component carrier data transmission in the LTE network in accordance with a method of configuring a data transmission scheme based on data frames in the LTE network according to an exemplary embodiment of the invention.

FIG. 5 illustrates an allocation of data transmission resources for an uplink data transmission illustrated in FIG. 4.

FIG. 6 illustrates a two component carrier data transmission in the LTE network in accordance with a method of configuring a data transmission scheme based on data frames in the LTE network according to another exemplary embodiment of the invention.

FIG. 7 illustrates a constitution of an eNode B according to an exemplary embodiment of the invention.

FIG. 8 illustrates a constitution of an eNode B according to another exemplary embodiment of the invention.

### DETAILED DESCRIPTION

The illustration in the drawing is schematic. It is noted that in different figures similar or identical elements are provided with the same reference signs or with reference signs which are different from the respective reference signs only within the first digit.

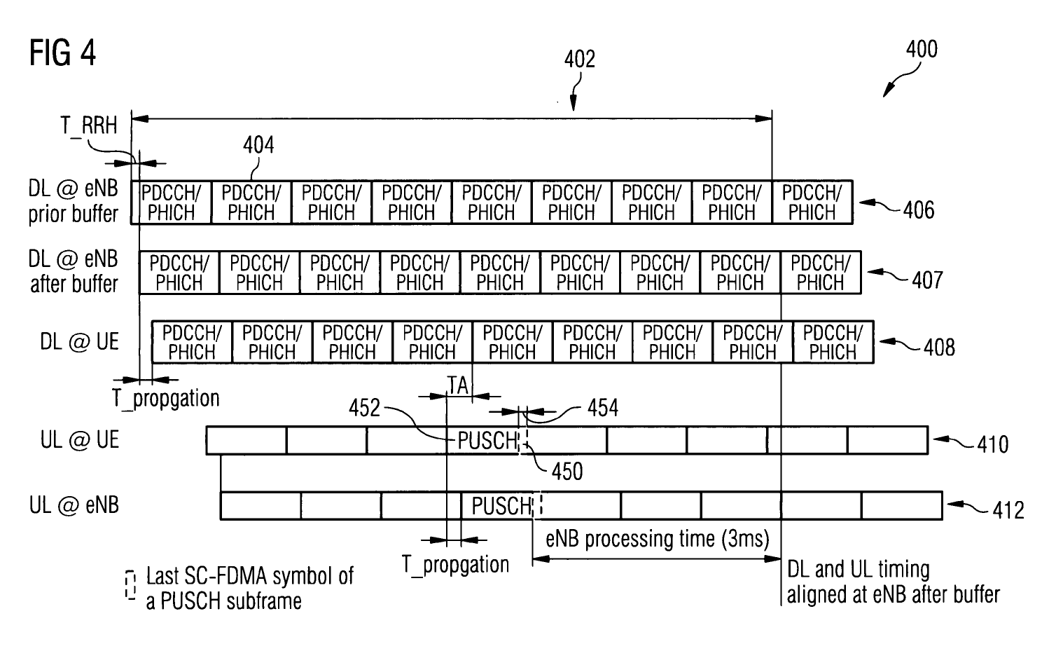

Referring to FIG. 4, a data transmission 400 in accordance with a method of configuring a data transmission scheme based on data frames in the LTE network according to an exemplary aspect of the invention is shown.

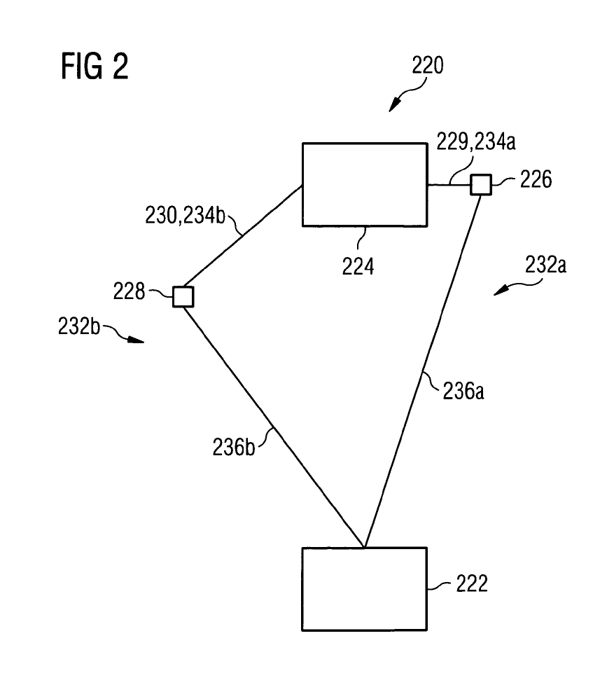

The data transmission 400 is associated with a single carrier (or non carrier aggregation) LTE network architecture in which an eNode B comprises an RF module and a RRH as transceiver units for communicating with a user equipment. Further, the data transmission 400 employs FDD and is based on non TTI bundling. One signal is sent from the eNode B to the user equipment during a downlink data transmission, and one signal is sent from the user equipment to the eNode B during an uplink data transmission. With reference to FIG. 2, both the downlink and uplink data transmissions may be associated with the data transmission paths 232a, b. The illustrated data transmission 400 represents the data transmission between the eNode B and the user equipment via the RF module.

For simplicity, the downlink and uplink data transmissions via the different data transmission paths will be referred to in the following as downlink and uplink data transmissions although being associated with single signals.

The downlink data transmission 406 via the RF module is delayed by a time T_RRH being approximately identical to a time delay of a downlink data transmission via the RRH in terms of a longer signal propagation time between the base band module of the eNode B and the RRH. Accordingly, the downlink data transmission 408 via the RF module is received delayed in time compared to an actual downlink data transmission via the RF module sent without T_RRH. Here, T_propagation represents the propagation time of the (not delayed) downlink data transmission 407 between the base band module of the eNode B and the user equipment via a RF module.

In order to compensate for the time delay T_RRH while maintain the HARQ round trip time of eight subframes, the data transmission scheme in accordance with the method according to the exemplary embodiment of the invention foresees a timing scheme of the uplink data transmission 410, 412 and an allocation scheme as to the data transmission resources of the uplink data transmission 410, 412.

The timing scheme of the data transmission scheme is based on a sending of the uplink data transmission 410 based on a time of a reception of the downlink data transmission via the RRH and using the conventional Timing Advance (TA) value of the cell of the eNode B which equals to two times the propagation time T_propagation of the downlink and uplink data transmissions 408, 412. Accordingly, the delayed downlink data transmission 408 via the RF module and the uplink data transmission 412 are synchronized in time, since, for example, subframe edges of the downlink and uplink data transmissions 408, 412 almost coincide in time.

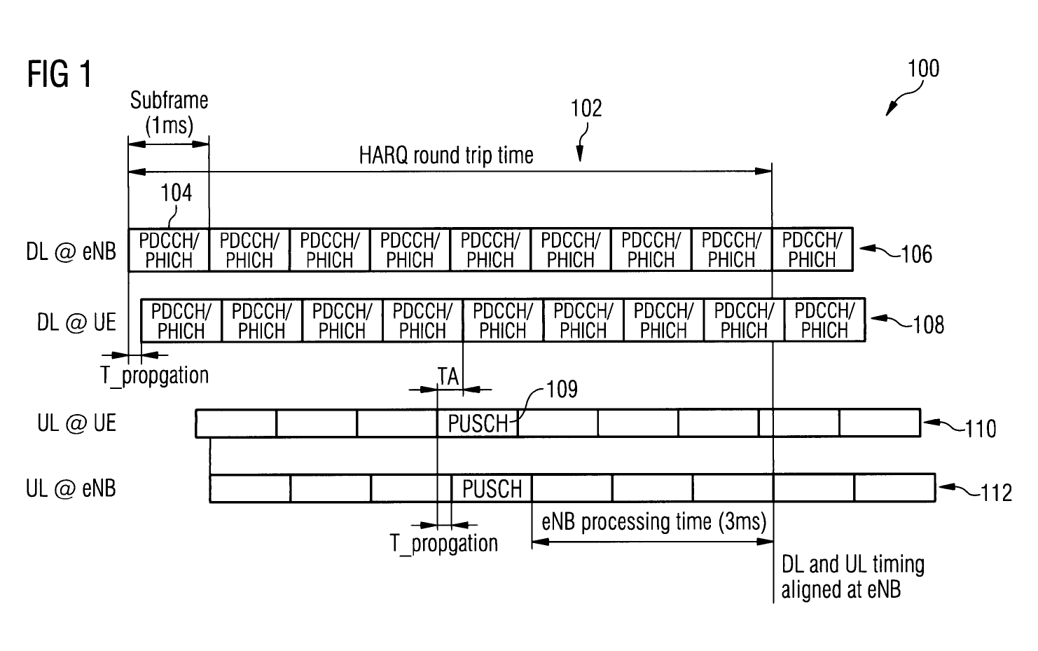

Since the TA value is identical compared to the conventional cell specification, a virtual maximum cell range is kept constant. Further, a user equipment processing time associated with a processing of data of the downlink data transmission via the RRH of 3 ms-TA is also not reduced compared to the data transmission 100 illustrated in FIG. 1.

Further, the data transmission scheme also foresees that a last symbol 450 of a subframe 452 of the uplink data transmission 410, 412 comprising payload data is allocated for non-payload data, namely a Sounding Reference Signal (SRS). Thus, only 13 (conventional cyclic prefix) symbols of the subframe 452 are allocated for payload data. For illustration purposes, the last symbol 450 is indicated by a dashed rectangle. A time length 454 of the last symbol 450 includes about 66.7 μs for the last symbol and a time length of about 4.3 μs for the CP interposed between the last symbol and the second last symbol.

The allocated SRS indicates a channel quality of the on-going uplink data transmission 410, 412 and is sent separate from PUSCH via PUCCH. Thus, the subframe length allocated for PUSCH is shortened by one symbol.

The eNode B starts processing the data of the received subframe 452 at a time of a reception of the last symbol allocated for payload data (here the 13th symbol of the subframe 452). Thus, the time point at which the eNode B starts processing the received payload data of the uplink data transmission 412 is earlier in time compared to the time point for staring the processing of the data of the subframe 109, as illustrated in FIG. 1. Thus, the eNode B processing time is increased by the time of the last symbol allocated for non-payload data and the CP time resulting in an increase of the eNode B processing time of 71.3 μs. In total, the eNode B processing time then adds up to 3 ms. Further, a cell range of the eNode B is kept constant, and a user equipment processing time for the uplink data transmission equals to 3 ms-TA.

The data transmission between the eNode B and the user equipment via the RRH is identical to the data transmission 400, since the signal sent by the eNode B to the user equipment and propagating via the RF module is delayed and only one signal is sent during the uplink data transmission.

It is noted that time shifts of data transmissions between an eNode B and the user equipment via two different RF modules are within the time length of the CP, such that an eNode B processing time for the uplink data transmission may not be reduced by a potential delay of downlink and/or uplink data transmissions of one of the RF modules.

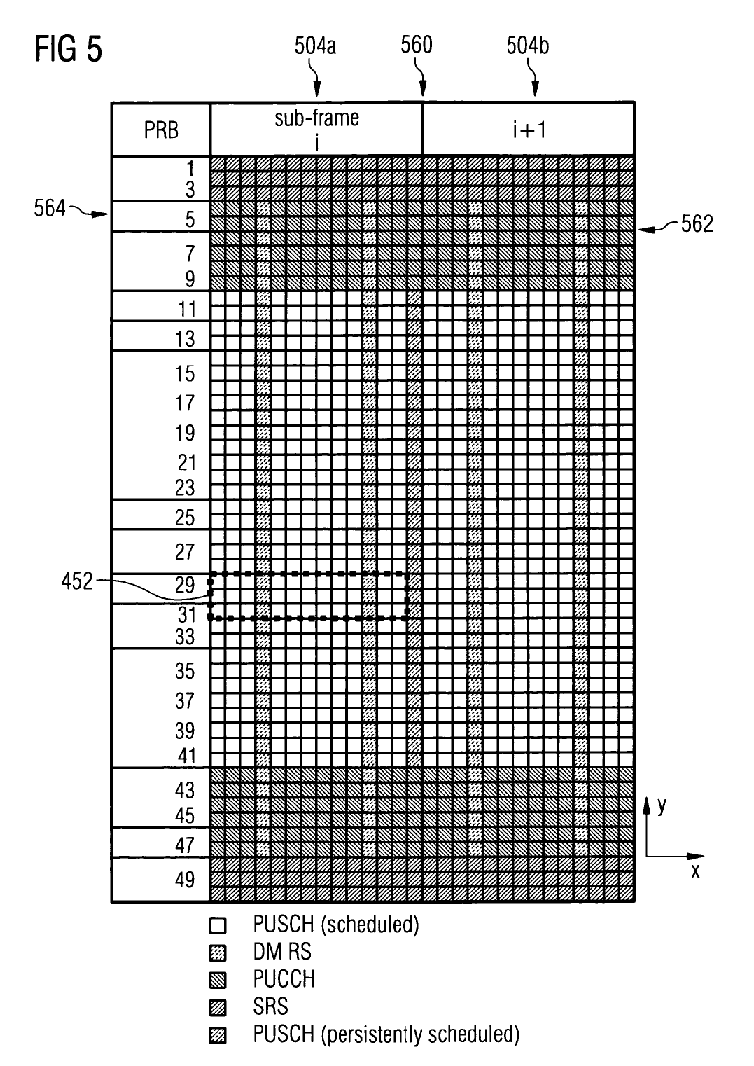

Referring to FIG. 5, an allocation of data resources for the uplink data transmission 410, 412 in accordance with the method of configuring a data transmission scheme based on data frames in the LTE network according to the exemplary aspect of the invention is illustrated.

The data resources 560 are distributed in time and frequency indicated by the coordination axes x and y, respectively. In the time direction, 14 SC-FDMA symbols 562 are allocated for each subframe 504a, b. In the frequency direction, the data resources 560 comprise 50 physical resource blocks 564 (denoted by PRB) each of which comprising a frequency range of 15 kHz (including frequency gaps between the frequency ranges of the physical resources blocks 564). A total band width of the uplink data transmission adds up to 10 MHz. One subframe 504a, b comprises a scalable bandwidth depending on the allocated amount of the physical resource blocks 564.

The symbols 562 of the three physical resource blocks 564 at the band edges are allocated for PUCCH comprising information such as a Channel Quality Indicator (CQI), Acknowledgment/Not-Acknowledgment (Ack/Nack) information etc. The twelve physical resource blocks 564 numbered as 4 to 9 and 42 to 47 are persistently allocated to PUSCH for transmitting payload data. The physical resource blocks 564 numbered as 10 to 41 are scheduled for PUSCH with the last symbol in time being allocated for the SRS. Further, every fourth and eleventh symbol 562 in time is allocated for a Demodulation Reference Signal (DM RS) usable for estimating a channel quality of the on-going uplink data transmission. The physical resource blocks 564 numbered as 4 to 9 and 42 to 47 may also be allocated like the physical resource blocks 564 numbered as 10 to 41.

The physical resource blocks 10 to 41 are shared between three user equipments with the physical resource blocks 10 to 25 being allocated for a first user equipment, the physical resource 26 to 33 being allocated for a second user equipment, and the physical resource blocks 34 to 41 being allocated for a third user equipment. In a case in which a user equipment may communicate with the eNode B only via RF modules, no allocation of the last symbol of the physical resource blocks 564 for non-payload data may be necessary.

The data transmission 400 of FIG. 4 is associated with the resource allocation of the second user equipment. The subframe 452 is the allocated subframe of FIG. 4. It comprises a frequency range of three physical resource blocks 564 and 14 symbols in time with the last symbol being the SRS.

In an uplink data transmission comprising four subframes the last symbol of the timely last fourth subframe may be allocated for the SRS. Such a data resources allocation for an uplink data transmission is referred to as uplink subframe bundling or TTI bundling.

The data transmission scheme described above with reference to FIGS. 4 and 5 results in a relaxed processing time requirement for PUSCH. Other uplink data transmissions signals such as SRS and other channels such as PUCCH which may occupy the last symbol of the allocated subframe may reduce the available processing time of the eNode B for PUSCH data. However, an eNode B processing time associated with processing the SRS and PUCCH information may not be critical compared to the processing time of payload data of PUSCH, since such processing times are significantly shorter than processing times for PUSCH.

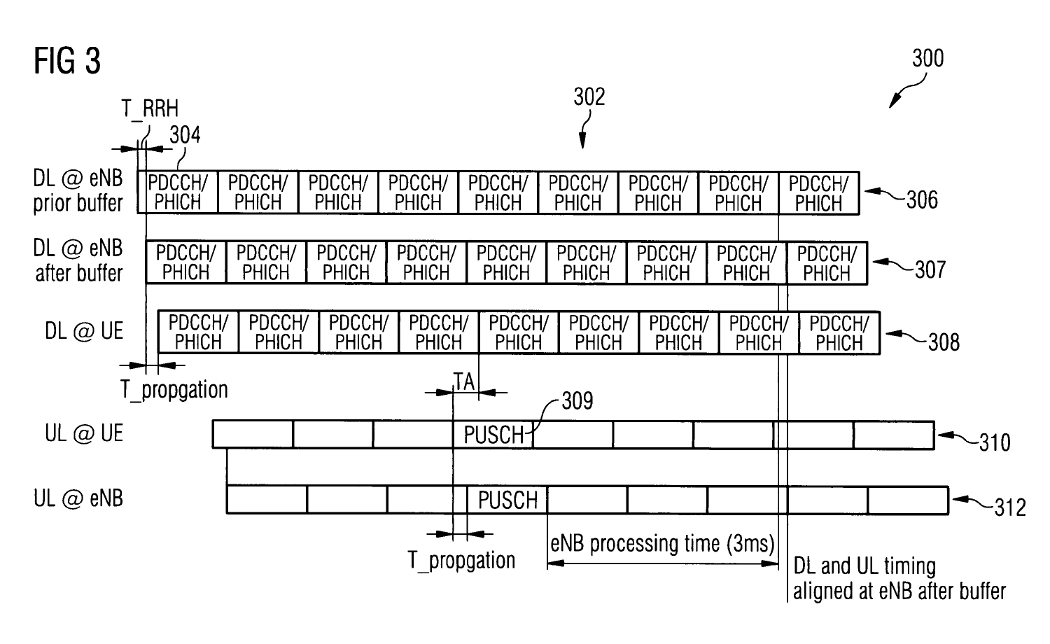

In general, a downlink delay compensation of up to 71.3 μs or 83.3 μs may be accomplished such that the eNode B processing time of 3 ms, a maximum cell range corresponding to the TA value, and a user equipment processing time of 3 ms-TA is preserved compared to the data transmission 300 illustrated in FIG. 3.

A delay of the uplink data transmission via the RRH may also be accounted for by the allocation of the last symbol of the subframe with the SRS.

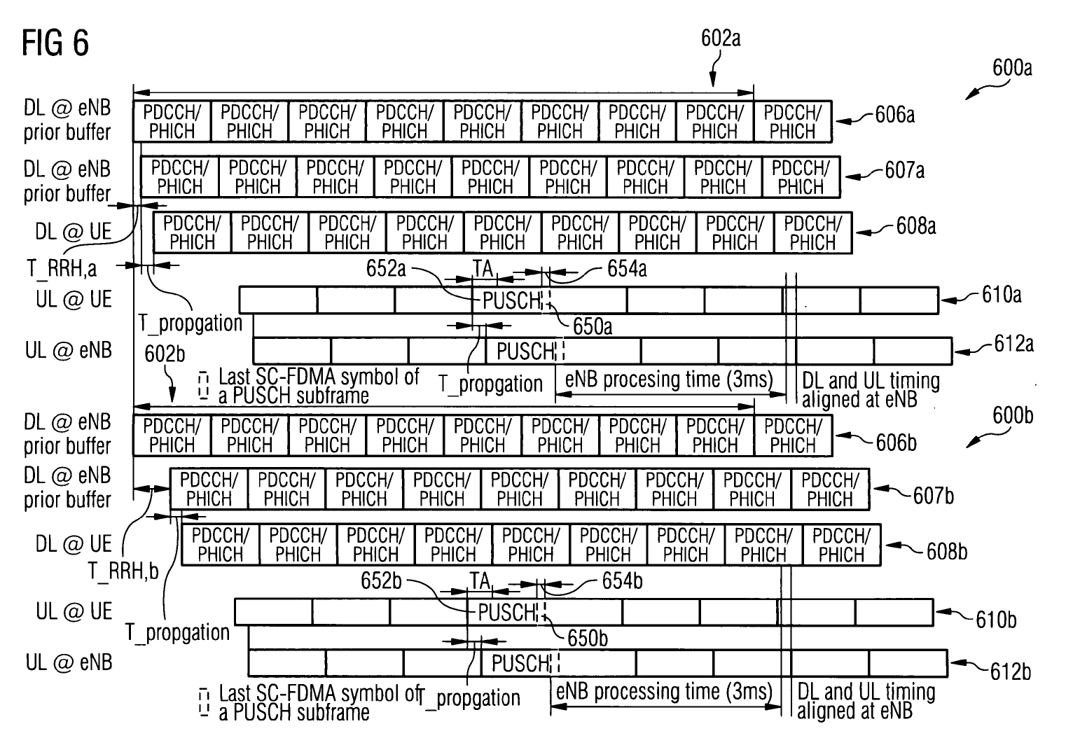

Referring to FIG. 6, a data transmission in accordance with a method of configuring a data transmission scheme based on data frames in the LTE-Advanced network according to another exemplary embodiment of the invention is illustrated. The underlying transmission architecture is associated with a carrier aggregation case in which data transmissions 600a, b are associated with a first component carrier and a second component carrier, respectively. In each component carrier, one signal is sent for the downlink data transmission and one signal is sent for the uplink data transmission. The first component carrier represents a so called primary component carrier, and the second component carrier represents a so called secondary component carrier. Uplink data transmissions of the secondary component carrier are conventionally synchronized in time to the downlink transmissions of the primary component carrier, i.e. the uplink data transmission associated with the secondary component carrier is sent based on a time of a reception of downlink data transmission associated with the primary component carrier. The data transmission employs FDD and is based on non TTI bundling.

The data transmission 600a associated with the first carrier component comprises a data transmission path from an eNode B to a user equipment via a first RRH both for the downlink and uplink directions. A data transmission 600b associated with the second carrier component comprises a data transmission path from the eNode B to the user equipment via a second RRH for the downlink and uplink directions with the second RRH being more remote from the eNode B than the first RRH.

The downlink data transmission 607b via the second RRH is delayed relative to a downlink data transmission 607a via the first RRH by a time T_RRH,b-T_RRH,a. Accordingly, a reception of the downlink data transmission 608b via the second RRH at the user equipment is delayed relative to a reception of the downlink data transmission 608a via the first RRH at the user equipment. Here, T_propagation denotes a signal propagation time of a not delayed signal sent between a base band module of the eNode B and the user equipment via a RF module. Further, T_propagation associated with the data transmissions 600a, b via the first and second RRHs are approximately the same. T_RRH,1 denotes a time delay of the signal propagation time of a signal sent from the base band module of the eNode B to the user equipment via the first RRH compared to the signal propagation time T_propagation. T_RRH,2 denotes a time delay of the signal propagation time of a signal sent from the base band module of the eNode B to the user equipment via the second RRH compared to the signal propagation time T_propagation. Synchronizing a sending of the uplink data transmissions 610b via the second RRH based on a time of a reception of the downlink data transmission 608a via the first RRH would result in a reduced processing time of the user equipment for the received data of the downlink data transmission 608b via the second RRH.

Thus, the data transmission scheme foresees that the first component carrier synchronizes in time to the second component carrier in that the sending of the uplink data transmission 610a via the first RRH is delayed to a time of a sending of the uplink data transmission 610b via the RRH. Here, it is noted that TA values associated with the first and second component carriers are identical. Further, the data transmission scheme also defines the last symbol of an allocated subframe for the uplink data transmissions 610a, b, 612a, b to be allocated for non-payload data, namely for the SRS. Thus, an increased processing time of the eNode B of 3 ms for the uplink data transmissions 612a, b is achieved while maintaining the maximum cell range.

It is noted that, in terms of coinciding subframe edges, the downlink and uplink data transmissions 607b, 612b are synchronized in time but the downlink and uplink data transmissions 607a, 612a are not synchronized in time. The uplink data transmissions 612a, b are aligned in time to the down-link data transmission 608b.

The time delay T_RRH,a of the downlink data transmission 607a may equal to zero.

In order to enable the scheduled sending of the uplink data transmission 610a, the second component carrier associated with the data transmission 600b is defined as timing reference for the sending of the uplink data transmissions 610a, b via the first and second RRHs. To this end, the second component carrier is mapped to be the primary component carrier by defining suitable Primary System Broadcast Information provided to the user equipment upon entering the cell range of the eNode B. Alternatively, the eNode B may inform the user equipment about the second component carrier being the primary component carrier by sending a message comprising respective information.

It is noted that for TDD based data transmissions the uplink subframe timing is slightly advanced at the base band module of the eNode B compared to a downlink subframe timing by an increased value of TA, in order to allow for a uplink to downlink (reception to transmission) switching of the eNode B.

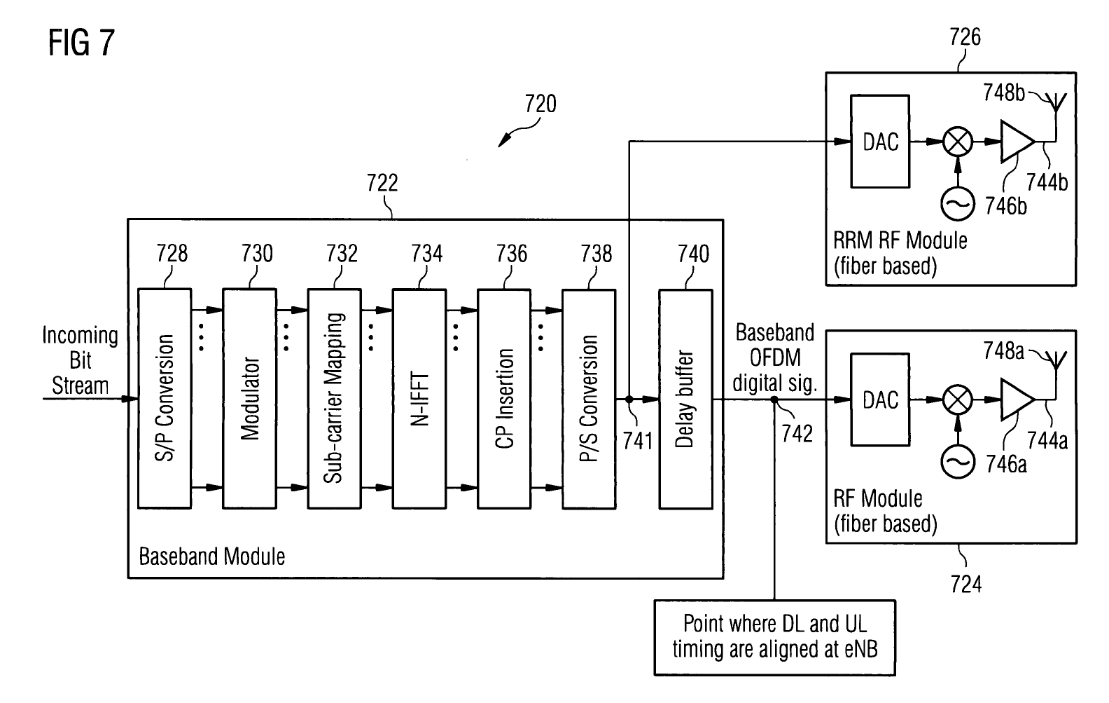

Referring to FIG. 7, a constitution of the eNode B configuring the data transmission schemes of the data transmissions 400, 600a, b of FIG. 4, 6 is illustrated. The eNode B 720 comprises a base band module 722, a first transceiver unit in the form of a RF module 724, namely an antenna, and a second transceiver unit in the form of a RRH RF module 726. The RF module 724 is arranged at the base band module 722, and the RRH RF module 726 is connected distantly to the base band module 722 via a fiber.

The base band module 722 comprises a serial to parallel (S/P) conversion unit 728 configured for converting a n-Bit data row vector to a n-Bit data column vector, a modulator unit 730 configured for converting the received Bits into QPSK or 16QAM or 64QAM symbols, a sub-carrier mapping unit 732 configured for distributing the symbols to sub-carriers of the data frames, a N-Inverted Fast Fourier Transformation unit 734 configured for converting a signal from frequency domain to time domain by means of a inverse Fast Fourier Transformation, a CP insertion unit 736 configured for inserting the CP between the transmitted data symbols, a parallel to serial (P/S) conversion unit 738 configured for converting the n-Bit column data signal to a n-Bit data row signal, and a delay buffer unit 740 configured for adding a delay to the signal fed to the RF module 724. Further, the identical signal or data is fed from a point 741 upstream of the delay buffer unit 740 to the RRH RF module 726.

In order to enable the data transmission timing schemes illustrated in FIG. 4, the downlink and uplink data transmissions 407, 412 are synchronized at a point 742 of the eNode B 720, respectively. The point 742 is arranged downstream of the buffer unit 740 and upstream of the RF module 724. Delaying the downlink data transmissions 607a, b is executed at points 744a, b corresponding to antenna connectors between diodes 746a, b and antennas 748a, b of the RF module 724 and the RRH RF module 726 of the eNode B 720, respectively.

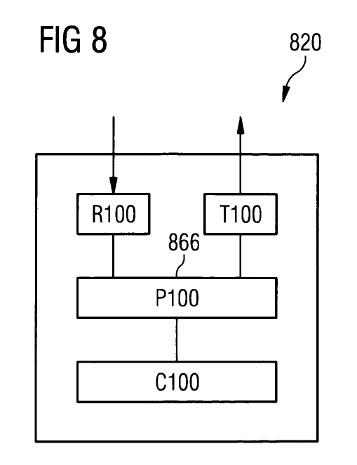

Referring to FIG. 8, a constitution of an eNode B 820 for configuring a data transmission scheme based on data frames in the LTE communication network according to another exemplary embodiment of the invention will be explained. The eNode B 820 comprises a transmitting unit T100 configured for sending information, particularly data, to a user equipment. Further, the eNode B 820 comprises a reception unit R100 configured for receiving information, particularly data, from the user equipment. Further, the eNode B 820 comprises a processing unit P100 configured for processing information, particularly data, associated with a method of configuring a data transmission scheme based on data frames in the LTE network, and a storage unit C100 configured for storing information, particularly data, associated with a method of configuring a data transmission scheme based on data frames in the LTE network. In particular, the processing unit P100 comprises a configuring unit 866 configured for configuring the data transmission scheme such that a reduction of a base station processing time associated with processing payload data of the data transmission is prevented.

In particular, the configuring unit 866 comprises a scheduling unit configured for scheduling a sending of the uplink data transmission based on a time of reception of the downlink data transmission via the second downlink data transmission path, and an allocating unit configured for allocating a last symbol of a subframe of one of the data frames of the uplink data transmission for non-payload data. However, the scheduling unit and the allocating unit may be embodied as separate units.

In addition or alternatively, the eNode B 820 may comprise at least one of the units or components of the eNode B 720.

It should be noted that the term “comprising” does not exclude other elements or steps and the use of articles “a” or “an” does not exclude a plurality. Also elements described in association with different embodiments may be combined. It should also be noted that reference signs in the claims should not be construed as limiting the scope of the claims.

1. A method of configuring a data transmission scheme based on data frames in a communication network, wherein communication in the communication network comprises a data transmission comprising downlink and uplink data transmissions via first and second data transmissions paths, the first and second data transmission paths comprising respective first and second downlink data transmission paths and respective first and second uplink data transmission paths, the downlink data transmission
via the second data transmission path being delayed to the downlink data transmission via the first downlink data transmission path, the method being executed by a base station, the method comprising
configuring the data transmission scheme such that a reduction of a base station processing time associated with processing payload data of the data transmission is prevented.

2. The method according to claim 1, wherein the configuring of the data transmission scheme comprises scheduling a sending of the uplink data transmission based on a time of a reception of the downlink data transmission via the second downlink data transmission path.

3. The method according to claim 1, wherein the configuring of the data transmission scheme comprises allocating a last symbol of a subframe of one of the data frames of the uplink data transmission for non-payload data.

4. The method according to claim 3, the allocating comprising allocating the last symbol of the subframe of the one of the data frames of the uplink data transmission for non-payload data for one or more frequencies.

5. The method according to claim 3, wherein the allocated subframe is a last subframe of a timely continuous uplink data transmission.

6. The method according to claim 3, wherein the non-payload data indicates a channel quality of an uplink data transmission.

7. The method according to claim 2, wherein the scheduling comprises defining first and second information indicating respective first and second timings (TA) for the sending of the uplink data transmission via the first and second uplink data transmission paths, wherein the first timing (TA) is identical to the second timing (TA).

8. The method according to claim 1, wherein the data transmission via the first data transmission path is associated with a first transmission carrier and the data transmission via the second data transmission paths is associated with a second transmission carrier.

9. The method according to claim 8, wherein the scheduling comprises defining the second transmission carrier as a timing reference for the sending of the uplink data transmission.

10. The method according to claim 8, wherein the scheduling comprises sending information indicating that the second transmission carrier is a timing reference for the sending of the uplink data transmission.

11. The method according to claim 1, wherein the data transmission via the first and second transmission paths are associated with one transmission carrier.

12. The method according to claim 11, wherein the scheduling comprises synchronizing in time the downlink data transmission via the first downlink data transmission path and the scheduled uplink transmission.

13. A base station for configuring a data transmission scheme based on data frames in a communication network, wherein communication in the communication network comprises a data transmission comprising downlink and uplink data transmissions via first and second data transmissions paths, the first and second data transmission paths comprising respective first and second downlink data transmission paths and respective first and second uplink data transmission paths, the downlink data transmission via the second data transmission path being delayed to the downlink data transmission via the first downlink data transmission path, the base station comprising
a configuring unit configured for configuring the data transmission scheme such that a reduction of a base station processing time associated with processing payload data of the data transmission is prevented.

14. The base station according to claim 13, wherein the base station is an eNode B of a Long Term Evolution communication network or a Long Term Evolution Advanced communication network.
